(19) United States
(12) Patent Application Publication
(10) Pub. No.: US 2006/0237083 A1
(43) Pub. Date: Oct. 26, 2006

(54) TRENCHLESS LINING DEVICE AND METHOD FOR PERFORMING MULTI-DIRECTIONAL CONDUIT LINING

(76) Inventor: Robert M. Ward, Silt, CO (US)

Correspondence Address: SHERIDAN ROSS PC, 1560 BROADWAY, SUITE 1200, DENVER, CO, 80202, US

(21) Appl. No.: 11/379,430

(22) Filed: Apr. 20, 2006

Related U.S. Application Data
(60) Provisional application No. 60/673,875, filed on Apr. 22, 2005.

(51) Int. Cl. F16L 55/16; F16L 55/18

(52) U.S. Cl. 138/98; 138/97; 405/184.2

(57) ABSTRACT

The present invention is generally related to a repair device for utility conduits, such as a sewer line. The present invention also effects repairs without the need for extensive excavation, thus alleviating many potential dangers associated with trenching operations. One embodiment of the present invention selectively engages at least two sections of damaged conduit through the access hole. After the liners inside the trenchless lining device are deployed into the damaged conduit, the device remains in the access hole to provide subsequent access to the conduit for repairs and/or inspections.

This application claims the benefit of U.S. Provisional Patent Application Ser. No. 60/673,875, filed Apr. 22, 2005, which is incorporated by reference in its entirety herein.

### FIELD OF THE INVENTION

The present invention is related to a device for lining a conduit to facilitate the repair of leaks. More specifically, one embodiment of the present invention interconnects to a conduit, such as utility pipe, to effect repairs thereto by deploying a liner wherein minimal digging to gain access to the conduit is required.

### BACKGROUND OF THE INVENTION

Repairs to utility conduits, such as sewer lines, are often an expensive and time consuming activity. Often, this task requires extensive soil excavation to gain access to damaged sections of the conduit, thereby increasing the probability that underground power or gas lines will be encountered and possibly damaged. Alternatively, conduits may be repaired by deploying a watertight liner therein. Liners are typically deployed inside a conduit by utilizing heated water or air to expand the predeployed liner thereby coating the inner diameter of the conduit. Curing agents integrated into the liner are activated by the heated water to harden to form a water tight barrier inside the damaged conduit. The liner is deployed with a device that allows for accessing the conduit via a hole as opposed to a trench.

Although trenchless conduit repair is known in the art, lining operations are often performed “one-way” between two access points of the conduit. More specifically, prior art methods employ a trench that is dug in an area of the conduit, the conduit is broken, and the liner is deployed in a single direction. This method is often expensive because additional repairs are required to patch the access location(s) of the conduit.

Thus there is a long felt need in the field of conduit repair to provide a device and method of repairing underground utility lines without expensive and time-consuming excavation and follow-up repairs. The following disclosure describes a device that deploys conduit liners in at least two directions, as opposed to one direction, and which is adapted to interconnect to a damaged conduit through a single access location and remain in place after the repair is completed.

### SUMMARY OF THE INVENTION

It is one aspect of the present invention to provide a device that repairs a conduit in multiple directions. More specifically, one embodiment of the present invention repairs a utility conduit in at least two distinct directions. This embodiment of the present invention that includes a chamber interconnected to a main tube that branches into a first auxiliary tube and a second auxiliary tube, is adapted to interconnect to a broken conduit to effect repairs in two directions. Conduit repair is achieved by excavating a single, generally cylindrical access hole over a damaged or weakened conduit. Next, the conduit is broken and a predetermined length is removed. The device is then placed in the hole and the first auxiliary tube and the second auxiliary tubes are placed adjacent to the ends of the broken conduit. The housing holds at least two liners, wherein the introduction of pressure into the chamber deploys the liner through the first auxiliary tube and through the second auxiliary tube, thus lining a predetermined length of conduit. Once the lining task is complete, heated fluid is introduced to the lined conduit to initiate the curing of the liner, thereby forming a watertight fluid line. Alternatively, the liner may be deployed with hot water to initiate the curing process as the liner is deployed.

It is another aspect of the present invention to provide a device that remains in the access hole after completion of lining operations, thereby providing an access point for future fluid conduit repair operations. More specifically, one embodiment of the present invention is designed to remain in the access hole to provide a link between the two sections of broken conduit. As mentioned above, generally, the point of entry to the utility conduit must be repaired subsequent to the lining of the conduit, in most trenchless lining operations. However, in this embodiment of the present invention, the repair step is omitted because the device remains in the access hole to provide a substantially uninterrupted fluid path. Further, it may be desirable to maintain an access point in the conduit to enable workers to perform future repairs or to monitor the conduit.

It is another aspect of the present invention to provide a method of trenchless pipe repair wherein multiple lines may be repaired at once. More specially, in one embodiment of the present invention, at least one chamber that houses a plurality of liners that deploy into a conduit in at least two directions is utilized. By decreasing the amount of labor performed on the areas overlying the pipe, the probability of striking electrical or gas lines is reduced, while decreasing the cost of the project, and thereby increasing the overall efficiency.

Thus, it is one aspect of the present invention to provide a trenchless lining devices which comprises:

a chamber, adapted to hold pressure and house a first liner and a second liner that are adapted for interconnection to a utility conduit;

a main conduit interconnected to said chamber;

a first auxiliary conduit interconnected to said main conduit;

a second auxiliary conduit interconnected to said main conduit and extending in a direction that is distinct from said first auxiliary conduit; and

wherein said first liner and said second liner are extended in two directions through said first auxiliary conduit and said second auxiliary conduit, respectively, when said chamber is pressurized.

It is a further aspect of the present invention to provide a method of repairing a utility conduit comprising:

obtaining access to a utility conduit by excavating an access hole;

providing a lining device comprising a chamber, a first auxiliary tube, and a second auxiliary tube, which houses a first liner and a second liner;

providing access to said utility conduit with a gap of predetermined length wherein said first auxiliary conduit and said second auxiliary conduit are placed adjacent to openings in the broken utility conduit; and

adding pressure to said chamber, thereby deploying said first liner and said second liner through said auxiliary tubes into said utility conduit.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these embodiments.

FIG. 1 is a front elevation view of one embodiment of the present invention shown interconnected to a conduit;

FIG. 2A is a detailed partial sectional view of the embodiment of the invention shown in FIG. 1 prior to a liner being placed in the conduit;

FIG. 2B is a detailed partial sectional view of the embodiment of the invention shown in FIG. 1 with the liner being placed in the conduit;

FIG. 3 is a cross-sectional front elevation view of one embodiment of the present invention shown in FIG. 1;

FIG. 4 is a detailed view of an upper portion of the embodiment depicted in FIG. 3;

FIG. 5 is a detailed view of the embodiment of the present invention in FIG. 3 wherein the liner is deployed within the conduit; and

FIG. 6 is a top plan view of the embodiment of the present invention shown in FIG. 1.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

To assist in the understanding of the present invention the following list of components and associated numbering found in the drawings is provided herein:

| Component | # |
|---|---|
| Trenchless lining device | 2 |
| Chamber | 4 |
| Main tube | 6 |
| First auxiliary tube | 8 |
| Second auxiliary tube | 10 |
| Liner | 12 |
| Access hole | 14 |
| Utility conduit | 16 |
| Cover | 18 |
| Cap | 20 |
| Pressure gauge | 22 |
| Air induction valve | 24 |
| Air supply | 26 |

### DETAILED DESCRIPTION

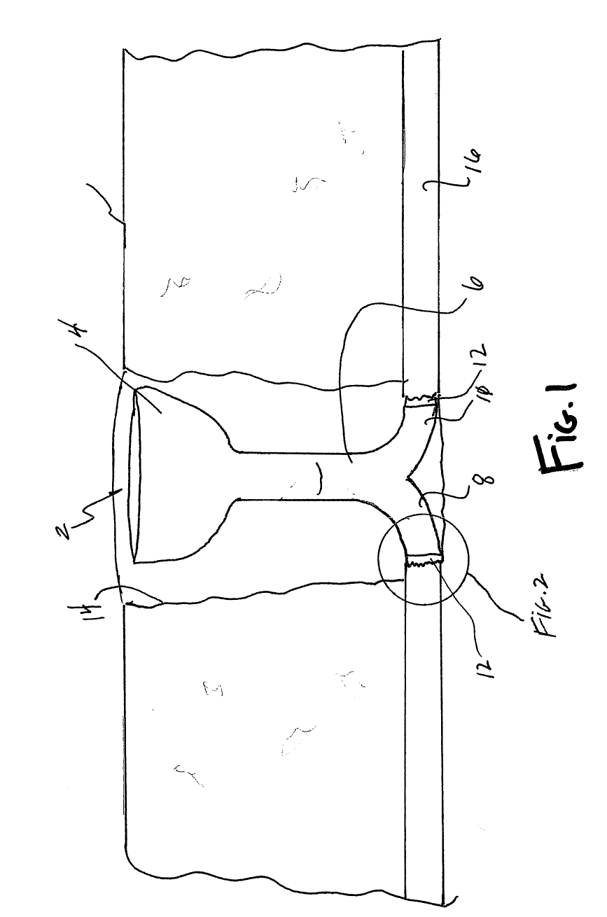

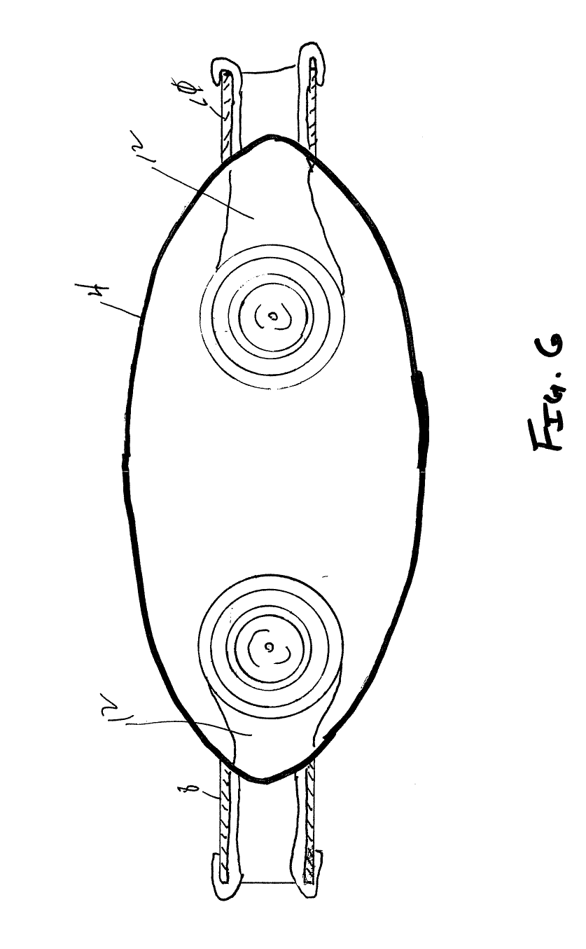

Referring now to FIGS. 1-6, a trenchless lining device 2 is shown. More specifically, one embodiment of the present invention generally comprises a chamber 4 in communication with a main tube 6 that branches off into at least a first auxiliary tube 8 and a second auxiliary tube 10. Upon installation into the ground, the ends of the auxiliary tubes are placed near the open ends of the damaged pipe. Liners 12, which are housed inside the chamber 4, are deployed into the damaged utility conduit when pressure is added to the chamber 4. Finally, heated fluid or heated air as introduced into the lined conduit, thereby curing the liner 12 to form a watertight barrier. One embodiment of the present invention is designed to remain inside the access hole after completion of the project.

Referring now to FIG. 1, one embodiment of the present invention is shown. More specifically, one embodiment of the present invention includes a bowl-shaped chamber 4 interconnected to the main tube that branches off into the first auxiliary tube 8 and the second auxiliary tube 10. Repair is initiated by excavating an access hole 14 over damaged areas of the utility conduit 16. The access hole 14 is significantly smaller than would be required for a trenched operation, wherein a large portion of the line 16 is generally exposed. Here, the hole 14 of about the same diameter of the chamber 4 is required. After the hole 14 is dug and the line 16 exposed, the line 16 is accessed and a predetermined length is removed to allow for positioning of the auxiliary tubes of the trenchless lining device 2. Once the trenchless lining device 2 is positioned, air or fluid is introduced into the chamber 4, thereby deploying the liners 12. After the lining operation is complete, backfill is added to the access hole 14, thereby covering the entire device 2, preferably cover the entire device 2. Alternatively, a lid 18 of the device 2 may be left exposed to provide a quick and easy access point to the utility conduit 16 for future repair and inspections of the line 16.

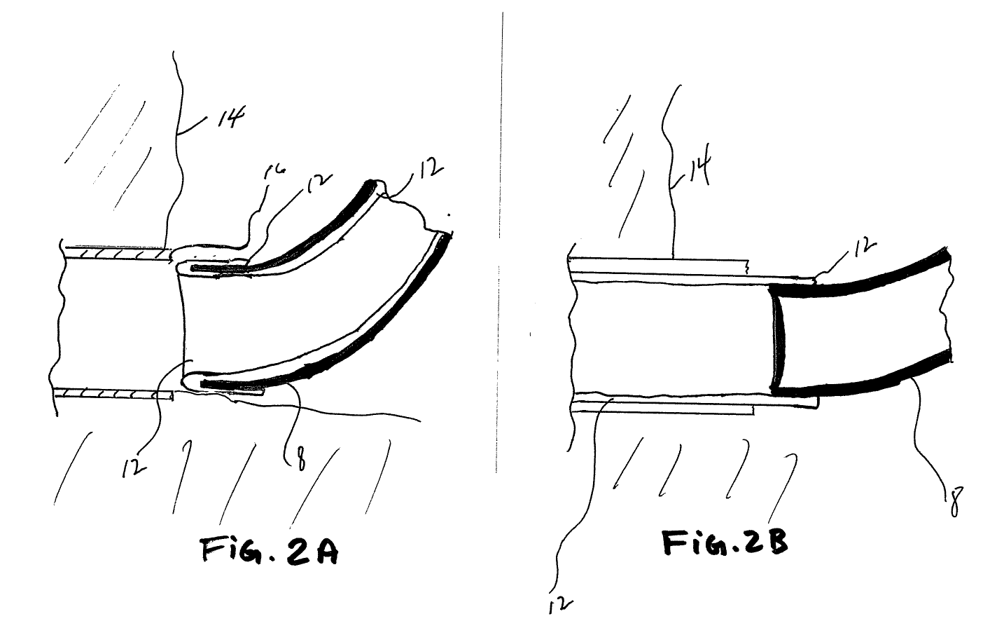

Referring now to FIG. 2, the deployment of the liner 12 is shown. In operation the auxiliary tubes are placed adjacent to or in the utility conduit 16. The liner 12 is affixed to an outer diameter of the auxiliary tubes, wherein the remaining portion of the liner 12 is housed within the auxiliary conduits, main conduit 6, and chamber 4 of the device. As seen more clearly in FIG. 2B, upon introduction of hydraulic or pneumatic pressure, the liner 12 inverts and deploys, thereby bridging any gap between the auxiliary tubes and the broken ends of the utility conduit 16.

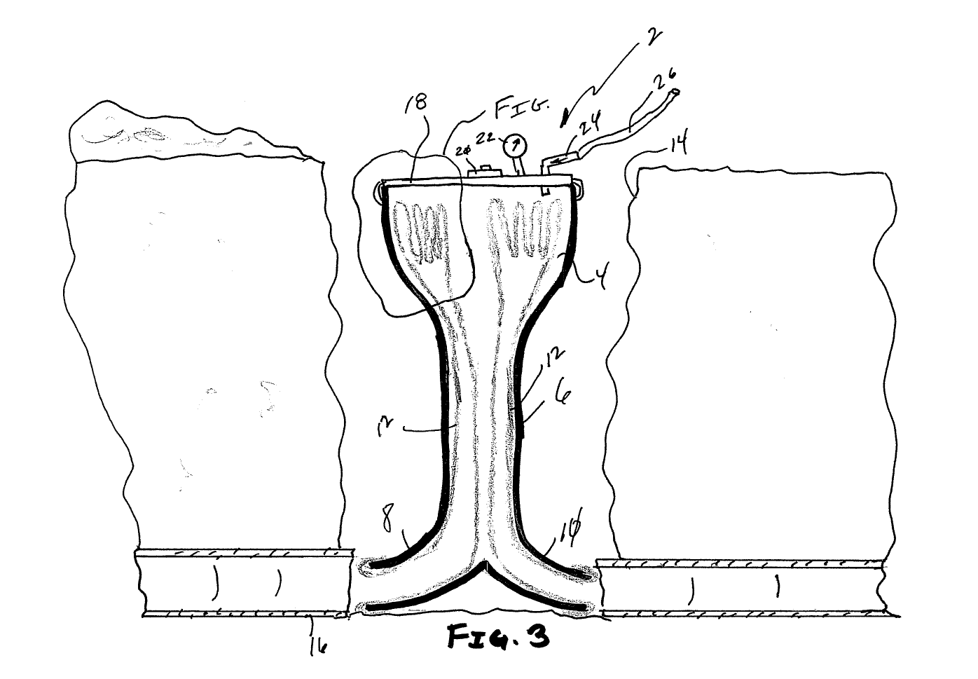

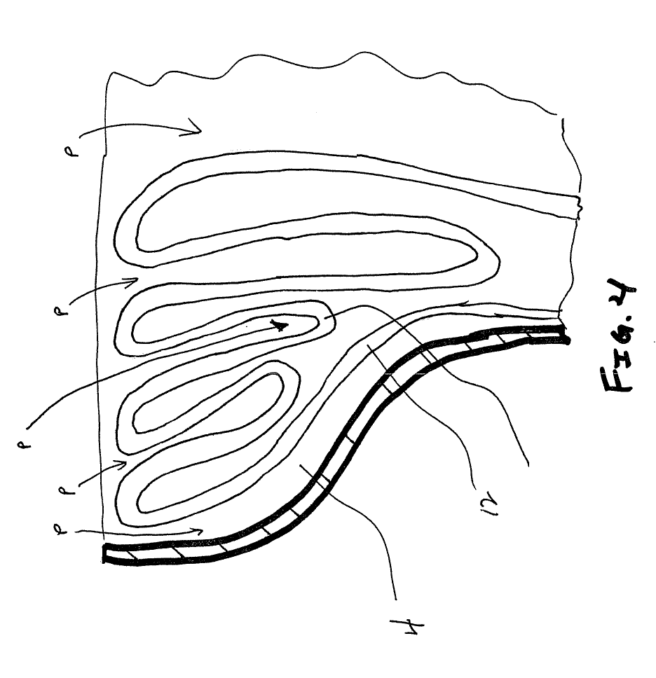

Referring now to FIGS. 3 and 4, the trenchless repair device of one embodiment of the present invention is shown that includes a folded liner 12 prior to its insertion into the utility conduit 16. The inverted liner 12 folds upon itself and is housed primarily inside the chamber 4. The chamber 4 also receives the cover 18 that generally includes a cap 20, a pressure gauge 22, and an air induction valve 24 interconnected to an air supply 24. Upon introduction of pressure either by air, through the air induction valve 24, or fluid, through the cap 18, the liners 12 will invert and be forced through the auxiliary conduits, thereby deploying into the utility conduit 16. In addition, the anchor locations of the liner on the auxiliary tubes ensure that the liners will not become disconnected from the trenchless lining device 2. Thus a flow path between the broken sections of the utility conduit 16 is formed. Subsequent to the repairs, workers may selectively disconnect the cap to insert probes, dyes, or other monitoring means to verify that the liner was placed properly. In some instances, it is desirable to deploy air through the main chamber to deploy the liners. Alternatively, it is often required to add heated fluid into the liners to initiate a curing process to harden the liners 12 to create a rigid barrier to carry fluids. In one embodiment of the present invention, a recirculation chamber is selectively interconnected to an aperture in the cover 18. The recirculation chamber distributes hot fluid into the chamber 4 and into the deployed liners 12, thus initiating the curing process. The water is then recirculated through a second port on the fluid circulation chamber to ensure the proper temperature of fluid is introduced to the liners 12.

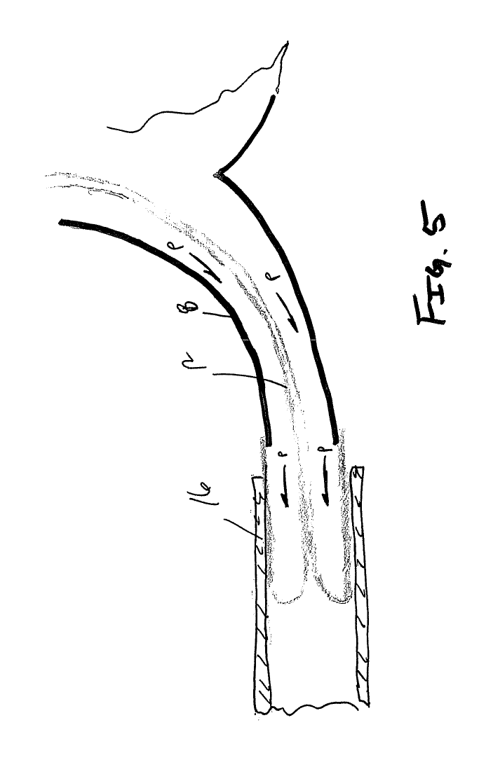

Referring now collectively to FIGS. 1-6, a method of repairing a conduit is shown and described. As briefly mentioned above, initially the damaged portion of the utility conduit 16 is identified by using probes, fiberoptic cameras, or other like devices inserted through a manhole. The access hole 14 is then excavated to gain selective access to a section of the conduit. Once the hole 14 is dug in the proper location, certain portions of the conduit 16 are removed, thereby allowing space to insert the auxiliary tubes of the trenchless lining device 2. The trenchless lining device is then inserted, wherein the ends of the auxiliary tubes are generally aligned to the broken ends of the conduit. Pressure is introduced into the closed chamber 4 to deploy the liners 12 into the utility conduits 16. In one embodiment of the present invention, the deployment of the liners 12 is performed with the use of air introduced through the air induction valve 24, that is interconnected to the cover 20 of the chamber 4. Alternatively, hydraulic pressure generated by water or other liquids may be used. As shown in more detail in FIG. 5, the liner 12 is initially inverted when housed in the chamber 4. Upon introduction of pressure into the closed chamber 4, the liner is forced to right itself, thereby deploying into the utility conduit. In order to maintain a positive pressure differential within the liner, one embodiment of the invention includes a capping mechanism. This capping mechanism may be a closed liner end that is subsequently severed to provide an obstruction free path through the conduit. Alternatively, a removable plug is employed. Next, the cap 20 is removed from the cover 18 of the chamber 4 and the fluid recirculation device is selectively interconnected thereto. Heated fluid, such as water, is then introduced into the recirculation chamber that feeds the heated water into the chamber 4 and then into the lined portions of the conduit 16, thereby curing the liners 12. Once curing is complete, the fluid recirculation chamber is removed and the cap 20 replaced on the cover 18 of the chamber 4. Finally, backfill is added to the access hole 14 to stabilize the trenchless lining device 2 therein.

While various embodiments of the present invention have been described in detail, it is apparent that modifications and adaptations of those embodiments will occur to those skilled in the art. However, it is to be expressly understood that such modifications and adaptations are within the scope and spirit of the present invention, as set forth in the following claims.

What is claimed is:

1. A device adapted to repair a section of conduit, comprising:
a chamber adapted to hold pressure and house a first liner and a second liner that are adapted for interconnection to a utility conduit;
a first auxiliary tube interconnected to said chamber;
a second auxiliary tube interconnected to said chamber; and
wherein said first liner and said second liner are extended in two directions through said first auxiliary tube and said second auxiliary tube, respectively when said chamber is pressurized, wherein communication is provided between the first auxiliary pipe and said second auxiliary pipe.

2. The device of claim 1, wherein said first auxiliary tube and said second auxiliary tube are adapted to be situated adjacent to broken ends of a conduit to be repaired.

3. The device of claim 1, wherein when said chamber is pressurized said first liner is deployed within the conduit in a first direction and said second liner is deployed in a second direction.

4. The device of claim 1, further comprising a cover interconnected to an upper lip of said chamber.

5. The device of claim 4, further comprising at least one of a cap, a pressure gauge, and an air introduction valve interconnected to said cover.

6. The device of claim 1, wherein a main tube interconnects said chamber to said first auxiliary tube and to said second auxiliary tube.

7. The device of claim 6, wherein extending said first auxiliary tube is situated in a direction that is distinct from said main conduit.

8. The device of claim 6, wherein extending said second auxiliary tube is situated in a direction that is distinct from said main conduit.

9. The device of claim 6, wherein extending said first auxiliary tube and said second auxiliary tube is situated in a direction that is distinct from said main conduit.

10. The device of claim 1, further comprising an air supply means interconnected to said chamber.

11. The device of claim 1, wherein at least one of said first liner and said second liner includes a curing agent.

12. A method of repairing a utility conduit comprising the steps of:
obtaining access to said utility conduit by excavating an access hole;
providing a lining device comprising a chamber, a first auxiliary tube, and a second auxiliary tube which houses a first liner and a second liner;
providing access to said utility conduit with a gap of a predetermined length wherein said first auxiliary conduit and said second auxiliary conduit are placed adjacent to openings in the broken utility conduit; and
adding pressure to said chamber, thereby deploying said first liner and said second liner through said auxiliary tubes into said utility conduit.

13. The method of claim 12, wherein said adding pressure is performed by the introduction of pressurized air into said chamber.

14. The method of claim 12, wherein said adding pressure is performed by the introduction of pressurized fluid into said chamber.

15. The method of claim 12, wherein said first liner and said second liner each include a curable agent that hardens said first liner and said second liner when they are exposed to at least one of a heated fluid, a heated air, and a combination thereof.

16. The method of claim 12, wherein adding pressure to said chamber is performed via an air supply line that is interconnected to said chamber.

17. The method of claim 12, wherein said providing access comprises severing said conduit.

18. The method of claim 12, wherein a main tube interconnects said chamber to said first auxiliary tube and a second auxiliary tube.

19. The method of claim 12, further comprising adding a cover to said chamber.

20. The method of claim 12, further comprising burying said chamber.
